(19) United States
(12) Patent Application Publication
(10) Pub. No.: US 2005/0216769 A1
(43) Pub. Date: Sep. 29, 2005

(54) Access source authentication method and system

(75) Inventors: Naoki Matsuoka, Kawasaki (JP); Masato Okuda, Kawasaki (JP); Hiroshi Tomonage, Kawasaki (JP)

Correspondence Address: SWIDLER BERLIN LLP, 3000 K STREET, NW, BOX IP, WASHINGTON, DC, 20007, US

(73) Assignee: Fujitsu Limited

(21) Appl. No.: 11/086,250

(22) Filed: Mar. 23, 2005

(30) Foreign Application Priority Data
Mar. 26, 2004 (JP) 2004-92469

(51) Int. Cl. H04L 9/00

(52) U.S. Cl. 713/201

(57) ABSTRACT

In an access source authentication method and system, an access node adds an ID of a physical line, through which a message has passed, to the message including a user ID from a fixed terminal of a user to be transferred to au authentication device through the physical line, and the authentication device manages a relationship between a user ID and a physical line ID by a database, receives the user ID and the physical line ID transferred from the node and performs a user authentication by comparing the user ID and the physical line ID received with those in the database. Also, the authentication device generates an authentication ID in which the user ID and the physical line ID are encrypted, transmits the authentication ID to a request source of the authentication ID, an electronic commerce site through a request destination of the authentication ID, the fixed terminal and obtains the user ID and the physical line ID by decrypting the authentication ID when an authentication request including the authentication ID is received from the electronic commerce site, thereby enabling the user authentication to be performed.

### BACKGROUND OF THE INVENTION

1. Field of the Invention

The present invention relates to an access source authentication method and system, and in particular to an access source authentication method and system for safely and reliably authenticating a user who uses an electronic commerce site or the like.

2. Description of the Related Art

Electronic commerce using the Internet is widely being performed as an Internet environment comes into wider use. In order to safely and reliably perform the electronic commerce using the Internet, it is required to authenticate whether or not an access from a user existing on a network is authorized.

In the prior art electronic commerce using the Internet, logical individual information such as an IP/MAC address, an ID and a password, an electronic certificate specific to a user terminal transmitted from a user is compared with individual information preliminarily registered in an authentication device, thereby verifying a validity of the user and preventing an unauthorized access (see e.g. patent document 1).

The prior art example as mentioned above will now be described referring to FIG. 12.

It is supposed that a user U1 located on a side of an in-house device (fixed terminal) 10 is a user himself. When the user U1 performs a notification (1) of his ID, password, etc to an electronic commerce site 1 through a network NW from the fixed terminal 10, the electronic commerce site 1 performs an authentication request (2) to an authentication device 200.

The authentication device 200 is composed of an authentication database portion 201 and an authentication processor 202. The authentication database portion 201 is provided with a database DB10 associating a user ID and a password with an IP/MAC address. The authentication processor 202 in the authentication device 200 extracts the user ID and the password from the fixed terminal 10 complying with the authentication request (2) from the electronic commerce site 1, and further extracts the IP/MAC address of the fixed terminal 10.

The authentication processor 202 retrieves the IP/MAC address corresponding to the combination of the user ID and the password thus extracted from the database DB10, and further compares the retrieved IP/MAC address with the IP/MAC address extracted as the fixed terminal 10. As a result, when both are coincident, an authentication result (3) of regarding the access as an authorized access is transmitted to the electronic commerce site 1. When both are not coincident, an authentication result (3) of regarding the access as an unarthorized access is transmitted to the electronic commerce site 1. Therefore, when a wrong ID or password is inputted from the fixed terminal 10 of the user U1, the electronic commerce site 1 rejects the electronic commerce with the user U1 of the fixed terminal 10. [Patent document 1] Japanese Patent Application Laid-open No. 2002-83242

Since the IP/MAC address specific to the user terminal used for the above-mentioned prior art authentication method is easily personated by other malicious users, he can easily pretend to be a real user.

Namely, when a malicious user U2 pretends to be the real user U1 and performs, in a fixed terminal 11 shown in FIG. 12, a notification (4) of the ID and the password of the real user U1 to the electronic commerce site 1, the electronic commerce site 1 is to authenticate it as the authorized access in the same way as the case of the access by the real user U1 from the fixed terminal 10.

Additionally, as for the electronic certificate, the ID, the password or the like, the malicious user can easily pretend to be a real user by using information obtained by improper means.

Also, since individual information except the user ID and the password is required to be preliminarily registered in the database on the authentication device side, there has been a risk of individual information leakage to a third party due to a brittleness of security measures on the authentication device side.

### SUMMARY OF THE INVENTION

It is accordingly an object of the present invention to provide an access source authentication method and system which perform an authentication by taking advantage of information a user side can not personate and which do not leak individual information to a third party.

In order to achieve the above-mentioned object, an access source authentication method according to the present invention comprises: a first step of adding an ID of a physical line, through which a message has passed, to the message including a user ID (identifying information) from a fixed terminal of a user to be transferred through the physical line; and a second step of managing a relationship between a user ID and a physical line ID by a database, receiving the user ID and the physical line ID transferred by the first step and performing a user authentication by comparing the user ID and the physical line ID received with those in the database.

The above-mentioned second step may generate an authentication ID in which the user ID and the physical line ID are encrypted, may transmit the authentication ID to a request source of the authentication ID, an authentication request source system (e.g. electronic commerce site) through a request destination of the authentication ID, the fixed terminal, and may perform the user authentication by decrypting the authentication ID to obtain the user ID and the physical line ID when an authentication request including the authentication ID is received from the request source.

Also, the above-mentioned first step may further add an electronic certificate to the message in addition to the physical line ID, and the second step may verify a validity of the ID and physical line ID information in addition to the user authentication.

Also, when transmitting the authentication ID, the above-mentioned second step may set a flag indicating a presence/absence of an issue of the authentication ID, and when receiving the authentication request for the authentication ID from the request source, the second step may prevent an unauthorized access by a determination of the presence/absence of the flag.

Also, the above-mentioned second step may periodically change an encryption key for generating the authentication ID.

Also, the above-mentioned second step may incorporate an electronic certificate in the authentication ID, and may verify a validity of the authentication ID when the authentication request is received from the request source.

Furthermore, when receiving the message from the fixed terminal the above-mentioned second step may extract an IP address of the fixed terminal to be stored in the database, and when receiving the authentication request including an IP address of the user from the request source the second step may perform an authentication of the IP address of the fixed terminal by the IP address of the request source.

An access source authentication system according to the present invention which achieves the above-mentioned access source authentication method comprises: a node which is connected to a fixed terminal of a user by a physical line and which adds an ID of a physical line, through which a message has passed, to the message including a user ID from the fixed terminal to be transferred; and an authentication device which has a database for managing a relationship between a user ID and a physical line ID, and which performs a user authentication by comparing the user ID and the physical line ID from the node with those in the database.

The above-mentioned authentication device may generate an authentication ID in which the user ID and the physical line ID are encrypted, may transmit the authentication ID to a request source of the authentication ID, an authentication request source system through a request destination of the authentication ID, and may perform the user authentication by decrypting the authentication ID to obtain the user ID and the physical line ID when an authentication request including the authentication ID is received from the request source.

Also, the above-mentioned node may further add an electronic certificate to the message in addition to the physical line ID, and the authentication device may verify a validity of the user ID and the physical line ID in addition to the user authentication.

Also, when transmitting the authentication ID, the above-mentioned authentication device may set a flag indicating a presence/absence of an issue of the authentication ID, and when receiving the authentication request for the authentication ID, the authentication device may prevent an unauthorized access by a determination of the presence/absence of the flag.

Also, the above-mentioned authentication device may periodically change an encryption key for generating the authentication ID.

Also, the above-mentioned authentication device may incorporate an electronic certificate in the authentication ID, and may verify a validity of the authentication ID when the authentication request is received from the request source.

Also, when receiving the message from the fixed terminal the above-mentioned authentication device may extract an IP address of the fixed terminal to be stored in the database, and when receiving the authentication request including an IP address of the user from the request source the authentication device may perform an authentication of the IP address of the fixed terminal by an IP address from the request source.

The access source authentication method and system according to the present invention as mentioned above will now be clearly described referring to a principle diagram shown in FIG. 1.

Firstly, it is supposed that an electronic commerce site 1 and a fixed terminal 4 are in a communication state (1). When the electronic commerce site 1 performs an authentication request (2) to an authentication device 2 with respect to a user of the fixed terminal 4, the authentication device 2 further performs an authentication request (3) to the fixed terminal 4. On the other hand, a user ID-assigning portion 40 in the fixed terminal 4 transmits a message (4) including its own user ID to the authentication device 2. When the message reaches a node 3 accommodating an access line 5, the node 3, which is directly connected to the fixed terminal 4 by the access line 5 of the physical line, transmits the message to the authentication device 2 after a physical line ID-assigning portion 30 adds to the message a physical line ID of the access line 5 having received the message.

In the authentication device 2, an authentication database portion 21 holds a relationship between a user ID and a physical line ID (ID of access line 5) as a database DB1. Therefore, when an authentication processor 22 having received the message from the node 3 through an input/output message controller 3 retrieves the physical line ID corresponding to the user ID of the fixed terminal 4 from the database DB1, the authentication processor 22 determines whether or not the physical line ID is coincident with the physical line ID within the message transmitted from the node 3. When they are coincident with each other, the access is determined to be an authorized access; when they are not coincident with each other, the access is determined to be an unauthorized access. Thus, a user authentication in the fixed terminal 4 is performed, and the authentication device 2 performs a notification (5) to the electronic commerce site 1 to permit only the authorized access.

Thus, in the present invention, in order to exclude information personating pretender on the user side, a physical line ID of a network NW entrance which can not be personated on the user side is used as authentication information. Also, depending on whether or not the information of the physical line of the network entrance through which the message (traffic) has actually passed and the user ID are coincident with the information of the database DB1 managed by the authentication device 2, the access is determined to be authorized or unauthorized.

Also, in order to prevent leakage of individual information to a third party (used commerce site 1, etc), the authentication device 2 issues an authentication ID in which a user ID and an ID of a physical line having been actually passed are encrypted. Only the encrypted authentication ID is notified to a third party of an authentication request source through the fixed terminal 4 which is an authentication request destination. The third party inquires a user authentication of the authentication device 2 by using the encrypted authentication ID, thereby preventing the user individual information from leaking.

Furthermore, when adding the physical line ID of the network entrance through which the user message has actually passed, the node 3 may add an electronic certificate to the message, so that the authentication device 2 verifies the electronic certificate. Thus, an unauthorized authentication using the user ID and the physical line ID which an unarthorized user has improperly obtained can be more reliably prevented.

Furthermore, when the authentication device 2 issues the encrypted authentication ID as mentioned above, a control table CT in the authentication database portion 21 of the authentication device 2 holds a flag indicating that the authentication ID has been issued to the user. When the authentication request comes from a third party 1, the flag is confirmed in the control table CT. By regarding an authentication request to which a flag is not set as an unauthorized authentication, an unauthorized authentication access can be prevented.

Furthermore, when issuing the authentication ID, the authentication device 2 updates an encryption key periodically generating an authentication ID, thereby enabling a decryption by a packet capturing/snooping on the network to be prevented.

Furthermore, when issuing the authentication ID, the authentication device 2 assigns the electronic certificate to the above-mentioned encrypted authentication ID. When an authentication request is received from the third party 1, the electronic certificate included in the request is verified, thereby enabling an unauthorized access such as information falsification to be prevented.

Furthermore, when issuing the authentication ID, the authentication device 2 holds an IP address of the user fixed terminal 4 included in the message. When the third party 1 performs an authentication request, the authentication ID of the user and the IP address of the user are transmitted to the authentication device 2. The authentication device 2 performs an access source authentication, and compares the authentication ID and the IP address with the IP address held, so that the IP address of the user may be authenticated. Thus, the third party 1 trusts the IP address by the authentication of the IP address, so that an information notification is made possible.

As mentioned above, the access source authentication method and system according to the present invention can prevent personation of authentication information on the user side by using a physical line assigned on the network as information of the user authentication. Also, there is an effect of requiring no notification of user individual information such an ID or a password to the third party of the electronic commerce site or the like.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram illustrating a principle of an access source authentication method and system according to the present invention;

FIG. 2 is a diagram schematically illustrating an embodiment 1 of an access source authentication method and system according to the present invention;

FIG. 3 is an operational sequence diagram of the embodiment 1 shown in FIG. 2;

FIGS. 4A and 4B show diagrams showing a processing operation example of an access node used in the embodiment 1 shown in FIGS. 2 and 3;

FIGS. 5A and 5B show diagrams showing a processing operation example of an authentication device used in the embodiment 1 shown in FIGS. 2 and 3;

FIG. 6 is a diagram schematically illustrating an embodiment 2 of an access source authentication method and system according to the present invention;

FIG. 7 is an operational sequence diagram of the embodiment 2 shown in FIG. 6;

FIG. 8 is a flowchart showing an authentication ID issue processing in the authentication device shown in FIGS. 6 and 7;

FIG. 9 is a generation flow of an encrypted authentication ID/electronic certificate of the authentication device executed in FIG. 8;

FIG. 10 is a flowchart showing an operation of an authentication determination of the authentication device used in the embodiment 2 shown in FIGS. 6 and 7;

FIG. 11 is a diagram showing a verifying operation of an electronic certificate of the authentication device shown in FIG. 10; and

FIG. 12 is a block diagram showing an authentication system of a prior art example.

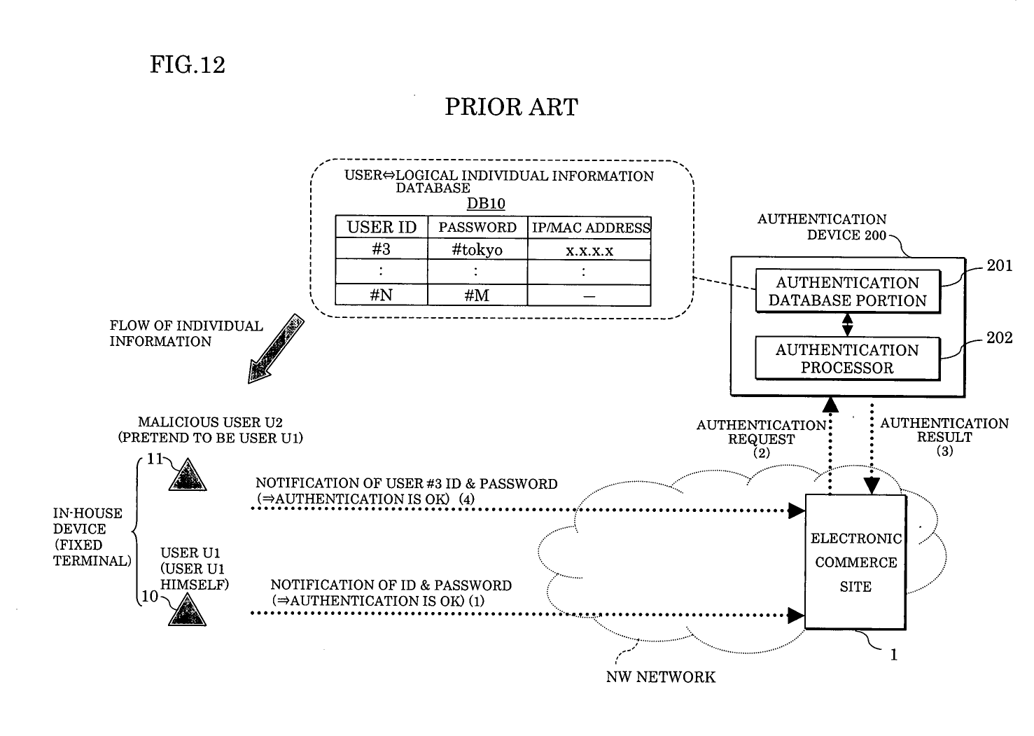

### DESCRIPTION OF THE EMBODIMENTS

### Embodiment 1

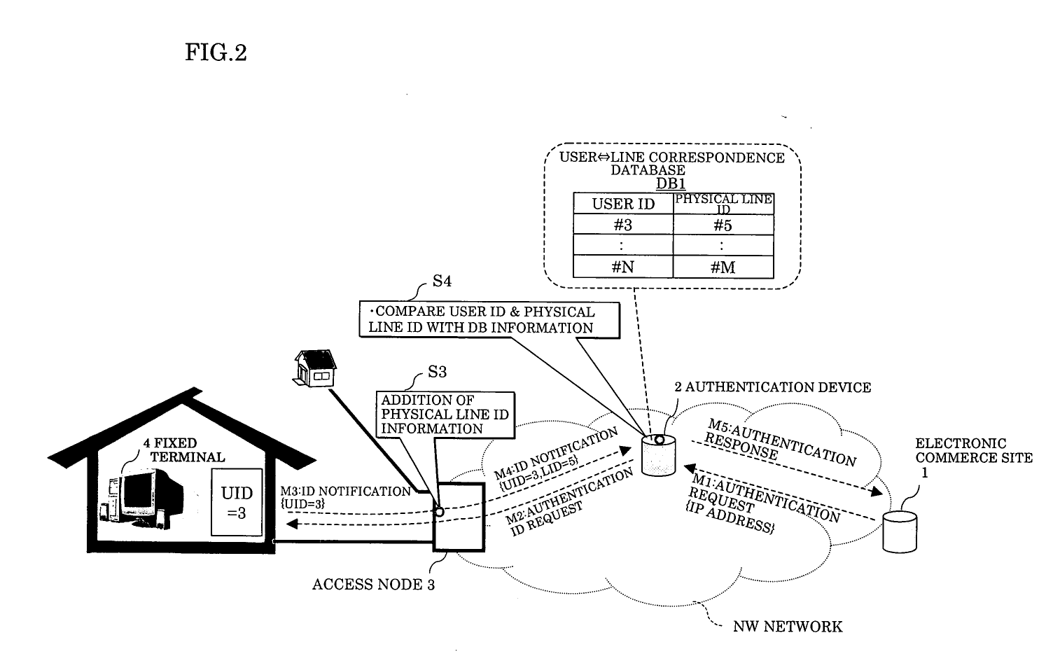

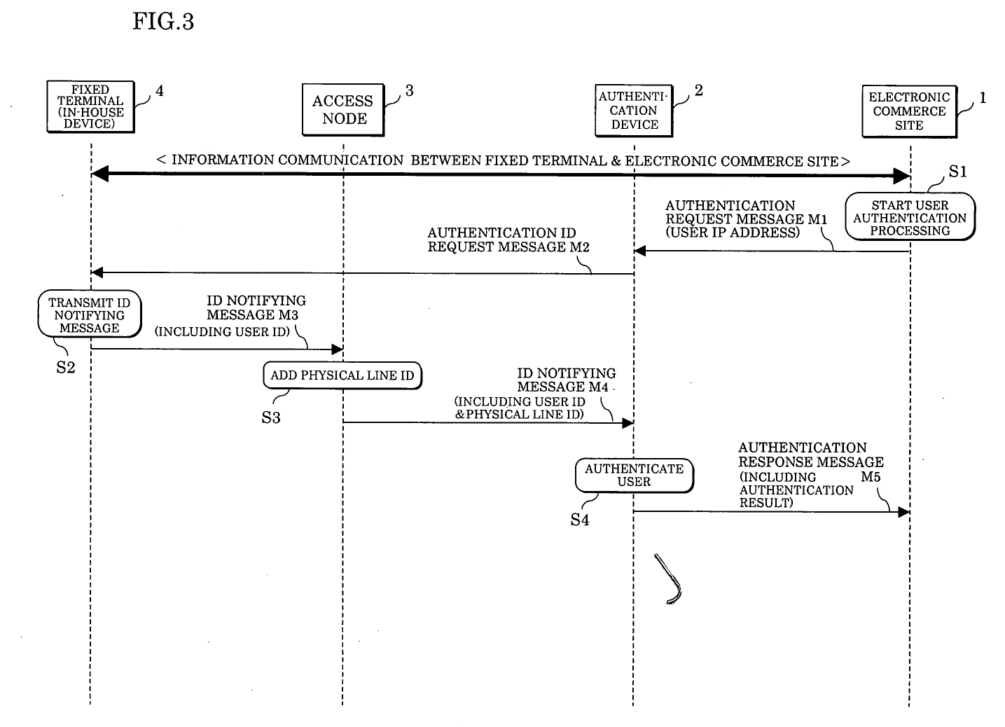

FIG. 2 schematically shows an embodiment 1 of an access source authentication method and system according to the present invention. FIG. 3 shows an operational sequence of FIG. 2. Hereinafter, the operation of the embodiment 1 will be described referring to FIGS. 2 and 3.

Firstly, it is supposed that the electronic commerce site 1 which is a third party for the user and the fixed terminal (in-house device) 4 where the user is located are in a communication state as shown by a thick arrow of FIG. 3. When e.g. the user of the fixed terminal 4 is a request destination which provides a commerce request (e.g. purchase request) to the electronic commerce site 1 in this state, the electronic commerce site 1 which is a request source starts processing the user authentication (at step S1 of FIG. 3). The electronic commerce site 1 provides an authentication request message M1 with the IP address of the accessing user as the authentication ID to the authentication device 2, thereby performing the authentication request.

An input/output message processor 23 in the authentication device 2 having received such an authentication request provides an authentication ID request message M2 to the fixed terminal 4 of the IP address within the authentication request message M1, thereby performing a request of the authentication ID to the fixed terminal 4.

The fixed terminal 4 having received such an authentication ID request from the authentication device 2 transmits an ID notifying message (at step S2 of FIG. 3). Thus, an ID notifying message M3 which is an specific packet including the user ID of the fixed terminal 4 is transmitted from the fixed terminal 4 to the access node 3 directly and physically connected to the fixed terminal 4 and placed at an entrance of the network NW. The message M3 can be identified by a specific IP protocol No. a port No. of TCP/UDP, a Length/Type value of an Ethernet (registered trademark) or the like. For the user ID included in the message, information which can be uniquely identified by the authentication device 2 such as a device ID, an IPv6 address, or the like specific to the fixed terminal 4 can be used. It is to be noted that the user ID (UID) of the fixed terminal 4 in this case is “3” as shown in FIG. 2.

The access node 3 having received such an ID notifying message M3 adds the physical line ID (LID) to the ID notifying message M3 as shown in FIG. 2 (at step S3 of FIGS. 2 and 3). The physical line ID is e.g. an input port No. corresponding to the access line 5, e.g. LID=“5”. The access node 3 transmits an ID notifying message M4 including the physical line ID and the above-mentioned user ID to the authentication device 2.

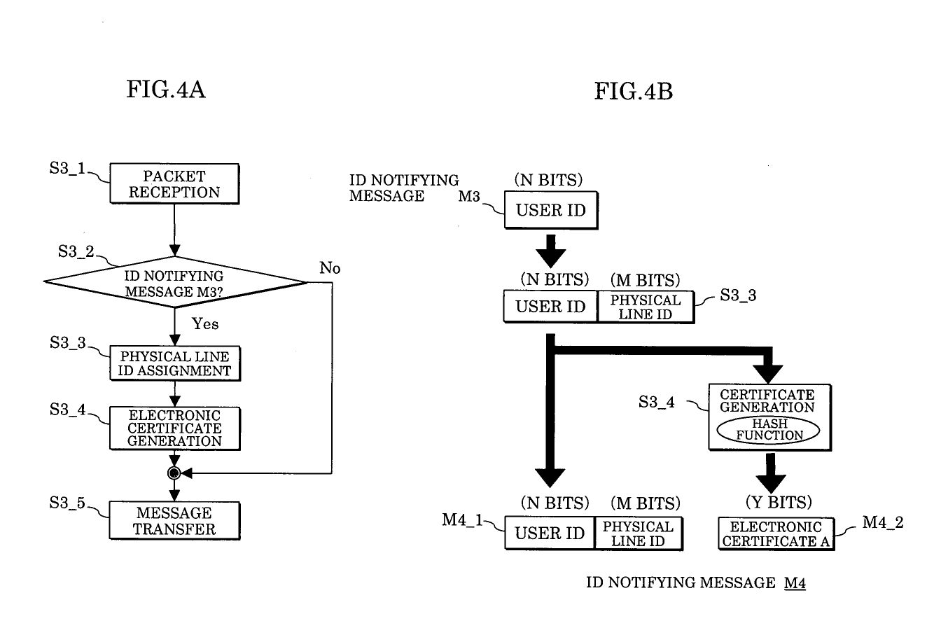

FIGS. 4A and 4B more specifically show a processing operation in the access node 3. Namely, as shown in the processing flow of FIG. 4A, if the access node 3 receives a packet (at step S3_1), whether or not the packet is the ID notifying message M3 is determined (at step S3_2). If it is not the ID notifying message M3, the process proceeds to step S3_5 without processing and transfers the message. If it is recognized that the packet is the ID notifying message M3, the access node adds to the message the physical line ID (LID=“5”) of the access line 5 having received the message M3 (at step S3_3).

As a more preferable state, the access node 3 generates an electronic certificate in addition to the physical line ID (at step S3_4), and then transfers the message M4 including the physical line ID and the electronic certificate to the authentication device 2 (at step S3_5).

FIG. 4B more clearly shows a generation flow of the electronic certificate shown at the above-mentioned step S3_4. As shown in this flow, when receiving e.g. N bits of ID notifying message M3, the access node 3 adds the physical line ID (e.g. M bits) to the user ID included in the message M3 as shown at step S3_3 to be transmitted to the authentication device 2 as the ID notifying message M4. In this case, as shown in FIG. 4B, the message M4 can be composed of a message M4_1 comprising the user ID and the physical line ID, and e.g. Y bits of electronic certificate A generated by a calculation such as a multiplication of the combination of the user ID and the physical line ID with e.g. a hash function (not limited to hash function but any function or a fixed value known to only the network carrier may be used) (at step S3_4). As a result, the ID notifying message M4 is combined with (N+N) bits of message M4_1 and Y bits of message M4_2 to be transmitted to the authentication device 2.

The authentication device 2 performs the user authentication based on the ID notifying message M4 received from the access node 3 (at step S4), and transmits an authentication response message M5 including the authentication result to the electronic commerce site 1.

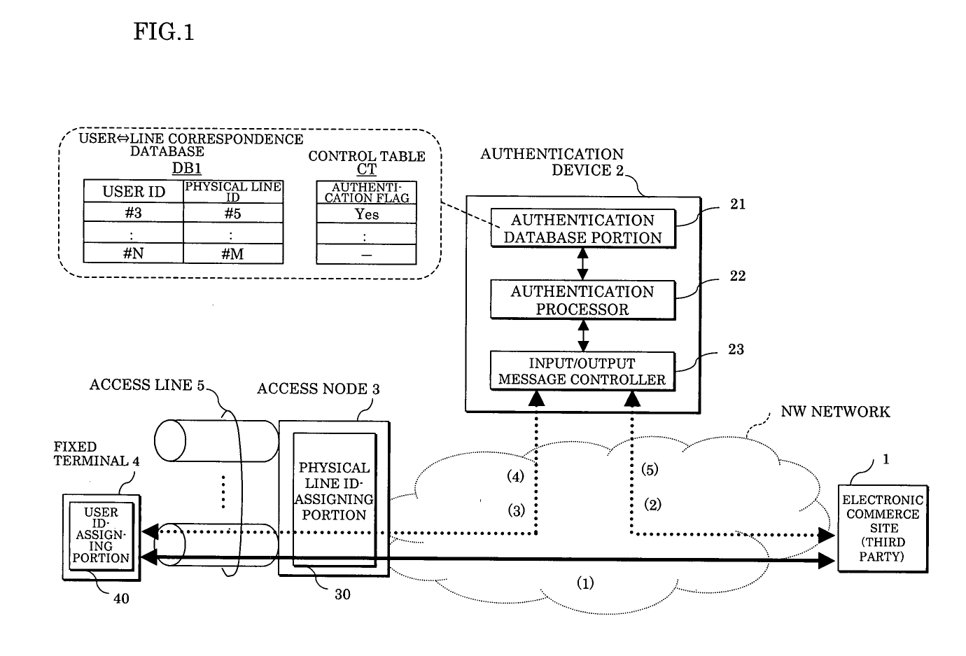

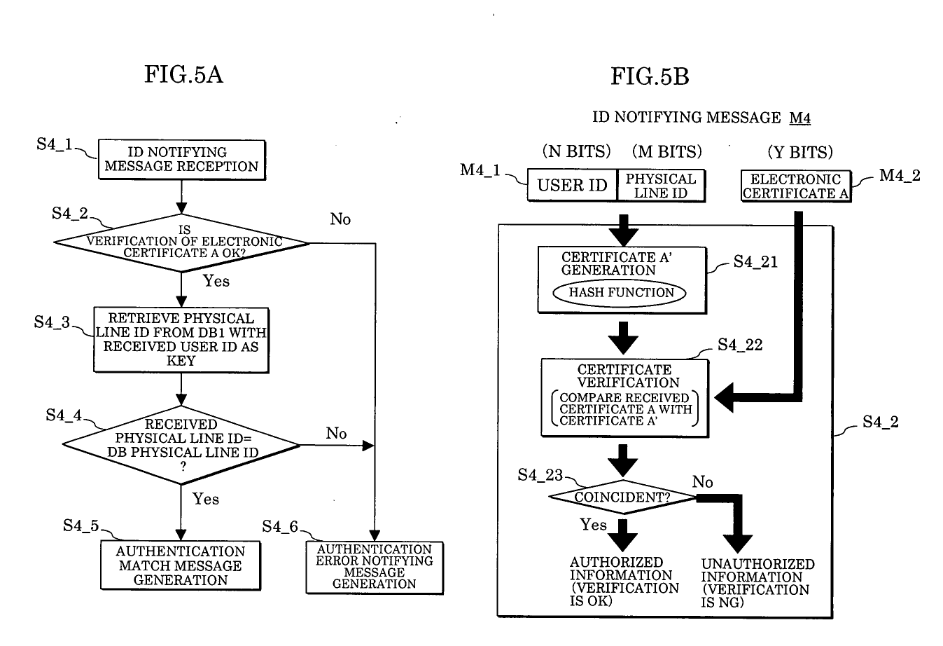

FIGS. 5A and 5B show an authentication processing flow of the authentication processor 22 in the authentication device 2. In FIG. 5A, when firstly receiving the ID notifying message M4 (at step S4_1), the authentication processor 22 verifies the electronic certificate A within the message M4_2 in the message M4 shown in FIG. 4B (at step S4_2). If the verification result is NG, the process proceeds to step S4_6, where an authentication error notification is generated and transmitted to the electronic commerce site 1 as the authentication response message M5. If the verification result is OK, the authentication device 2 retrieves the physical line ID (UID=“5”) from the database DB1 (stored in the authentication database portion 21 shown in FIG. 1) shown in FIG. 2 with the user ID (UID=“3”) within the message M4_1 in the received message M4 as a key (at step S4_3). The retrieved physical line ID is compared with the physical line ID received in the form included in the message M4_1 (at step S4_4). If both are equal to each other, the user is authenticated to be authorized to generate the message M5, and it is transmitted to the electronic commerce site 1 (at step S4_5). If both are different from each other, the process proceeds to step S4_6, the error message M5 is generated and notified to the electronic commerce site 1.

FIG. 5B shows a verification flow of the electronic certificate A shown at step S4_2 of FIG. 5A. In this verification flow, the message M4 generated in FIG. 4B and transmitted from the node 3 is divided into the messages M4_1 and M4_2 to be respectively inputted. With respect to the message M4_1, by multiplying the user ID and the physical line ID with the hash function (or fixed value) in the same way as the description of FIG. 4B, an electronic certificate A′ is generated in the authentication device 2 (at step S4_21). The electronic certificate A: thus generated is compared with the electronic certificate A included in the message M4_2 (at step S4_22). When both are coincident with each other, it is verified to be OK as authorized information, and the process proceeds to step S4_3 of FIG. 5A. When both are not coincident with each other, it is verified to be NG as unauthorized information, and the process proceeds to step S4_6 of FIG. 5A (at step S4_23).

Since the physical line ID received and the physical line ID managed in the database are the same in the embodiment 1, the access is regarded as an authorized access. If a malicious user pretends to own an IP address (information personation) of this user (user ID=3) and accesses the electronic commerce site 1, the access is determined to be unauthorized since the physical line ID in which the malicious user is accommodated is added to the ID notifying message notified to the authentication device 2. Also, if the user ID and the physical line ID flow out, and the malicious user generates the ID request message including the user ID and the physical line ID improperly obtained to be transmitted, the electronic certificate is added to the message when the physical line ID is added to the message in the access line node, so that the electronic certificate is verified when the ID notifying message is received on the authentication device side, thereby enabling an unauthorized access to be avoided.

### Embodiment 2

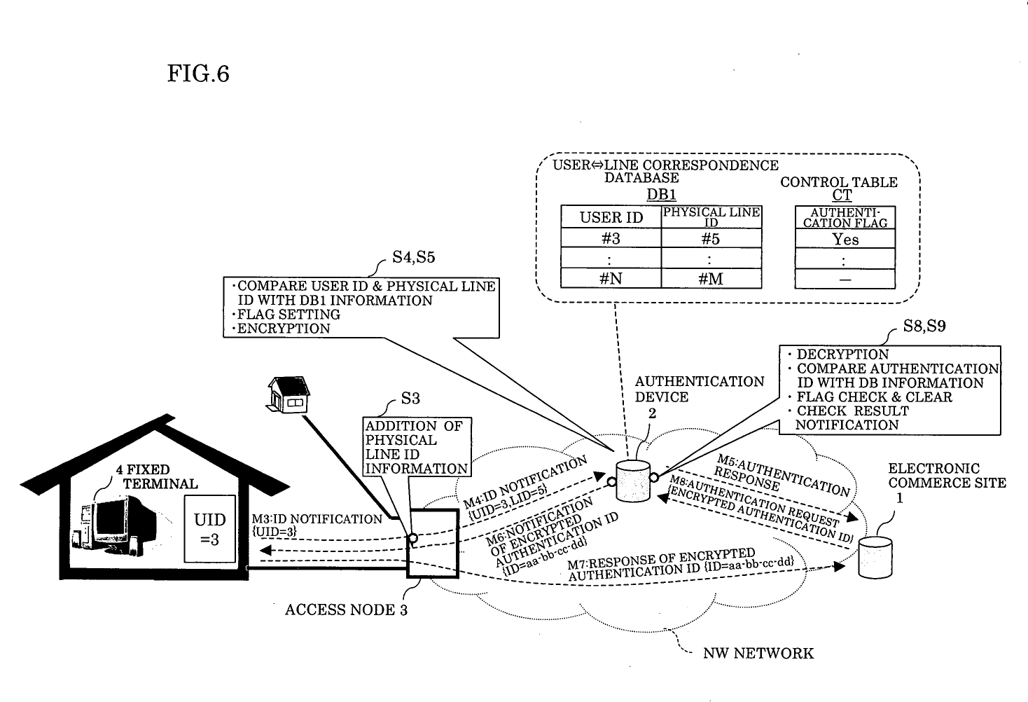

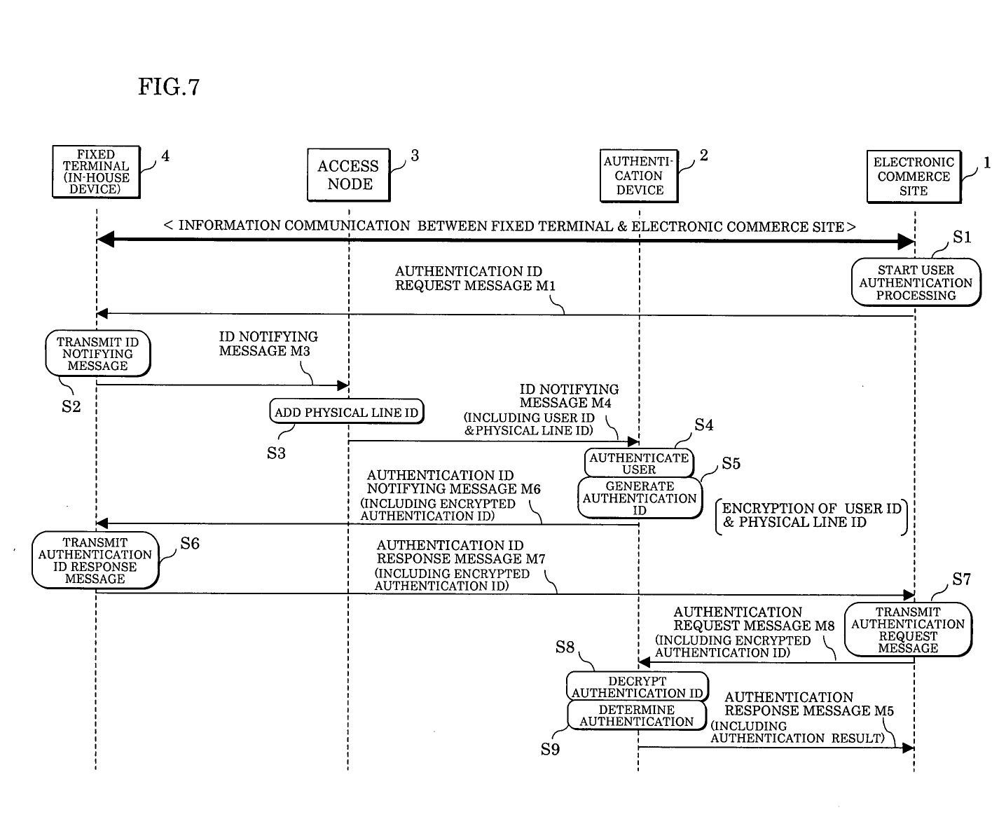

FIG. 6 schematically shows an embodiment 2 of the access source authentication method and system according to the present invention. FIG. 7 shows the operation sequence of this embodiment. Hereinafter, the operation of the embodiment 2 will be described referring to FIGS. 6 and 7 in the same way as the above-mentioned embodiment 1.

Firstly in the embodiment 2, as shown by a thick arrow of FIG. 7, it is supposed that the electronic commerce site 1 and the fixed terminal 4 are in the communication state, and the user has provided the electronic commerce request to the electronic commerce site 1 from the fixed terminal 4.

By this request, the processing of the user authentication is started at the electronic commerce site 1 (at step S1). In the embodiment 2, different from the embodiment 1, the user authentication is performed by transmitting an authentication ID request message M1 not to the authentication device 2 but directly to the fixed terminal 4 of the user. The fixed terminal 4 having received the message M1 transmits the ID notifying message (at step S2). As a result, the ID notifying message M3 is transmitted from the fixed terminal 4 to the access node 3 in the same way as the above-mentioned embodiment 1. Also in this case, as shown in FIG. 6, the user ID (UID) is supposed to be “3”.

The access node 3, in the same way as the above-mentioned embodiment 1, generates the ID notifying message M4 in the form where the physical line ID (LID) is added to the user ID to be transmitted to the authentication device 2 (at step S3). Also in this case, the physical line ID is supposed to be “5”. Also, in this embodiment 2, the access node 3 may, add an electronic certificate to the ID notifying message M4.

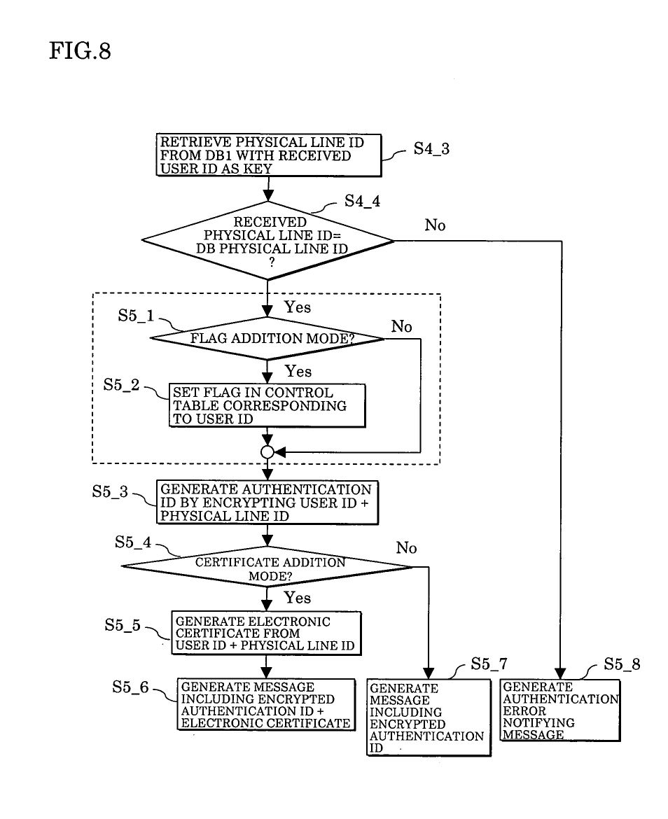

In the authentication processor 22 of the authentication device 2, the user authentication (at step S4) and the issue of the authentication ID (at step S5) are performed. This is performed, as shown in FIG. 8, by retrieving the physical line ID from the database DB1 with the received user ID as a key in the same way as steps S4_3 and S4_4 of FIG. 5A, and by determining whether or not the physical line ID retrieved is coincident with the physical line ID received. As a result, when both are not coincident with each other, the process proceeds to step S5_8 and an error message M6 is generated and transmitted to the fixed terminal 4.

On the other hand, when both are coincident with each other, it means that the user authentication the same as the embodiment 1 has been performed. However, the authentication device 2 does not transmit the authentication response message M5 to the electronic commerce site 1 at this stage, different from the above-mentioned embodiment 1. This is because the electronic commerce site 1 transmits the authentication request not to the authentication device 2 but to the fixed terminal 4.

The authentication device 2 performs processing related to a flag addition mode described later (at steps S5_1 and S5_2), encrypts the user ID and the physical line ID by using a secret key managed by the device itself and issues the authentication ID (ID=Oxaa-bb-cc-dd in the example of FIG. 6) (at step S5 of FIG. 7 and step S5_3 of FIG. 8). It is to be noted that the encryption is for preventing the user ID and the physical line ID from being revealed to the third party, the electronic commerce site 1 which has requested the authentication. For an algorithm of the encryption, a general-purpose algorithm such as DES, 3DES, AES can be used.

Then, whether or not the electronic certificate is added is determined (at step S5_4). When the authentication device 2 is set to a certificate addition mode in the embodiment 2, in the same way as the above-mentioned embodiment 1, the electronic certificate is generated from the user ID and the physical line ID in the same way as the generation flow of the electronic certificate shown in FIG. 4B (at step S5_5). In this case, the hash function may be multiplied in the same way as the above, or the remainder of the user ID+physical line ID divided by the encryption key may be made the electronic certificate. The authentication ID message M6 including the electronic certificate thus generated and the above-mentioned authentication ID is generated and transmitted to the fixed terminal 4 (at step S5_6).

On the other hand, when it is recognized that the authentication device 2 is not set to the certificate addition mode at step S5_4, the message M6 including only the encrypted authentication ID generated at step S5_3 is transmitted to the fixed terminal 4.

Whether or not the authentication device 2 is set to the flag addition mode is determined at step S5_1. Only when the flag addition mode is preset in the authentication device 2, a flag is set in a control table CT (see FIG. 6) provided to the database portion 21 in the form corresponding to the user ID at step S5_2. Thus, the flag addition mode is set in order to reduce the risk of an authentication ID suitably generated by a malicious user which may pass through the authentication device 2 even if the encrypted authentication ID is used.

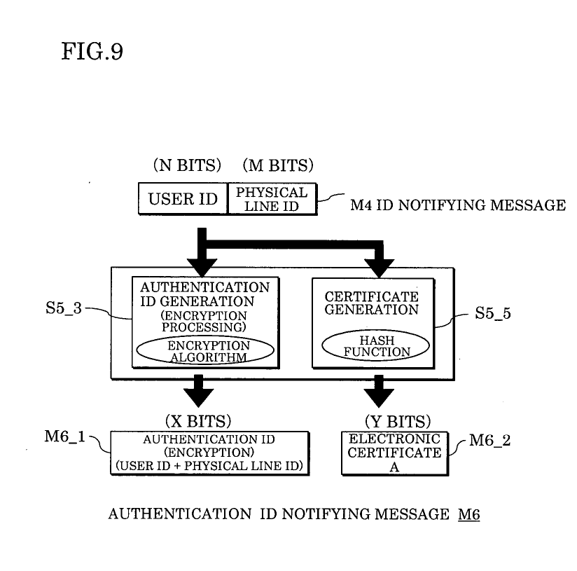

FIG. 9 more specifically shows a processing flow of steps S5_3 and S5_5 of FIG. 8. Namely, when receiving the ID notifying message M4 from the fixed terminal 4, the authentication device 2 performs encryption processing to the user ID and the physical line ID included in the message M4 as mentioned above (at step S5_3), thereby generating e.g. X bits of encrypted authentication ID message M6_1 of (at step S5_3). Also, by multiplying the user ID and the physical line ID with the hash function (at step S5_5), the authentication device 2 generates a message M6_2 of e.g. Y bits of electronic certificate A (at step S5_5). Then, the message M6_1 of the encrypted authentication ID and the message M6_2 of the electronic certificate A thus generated are transmitted from the authentication device 2 to the fixed terminal 4 as the message M6.

Thus, the fixed terminal 4 having received the authentication ID notifying message M6 including the encrypted authentication ID (Oxaa-bb-cc-dd) and preferably the electronic certificate from the authentication device 2 transmits an authentication ID response message (at step S6). This is transmitted from the fixed terminal 4 to the electronic commerce site 1 in the form of an authentication ID response message M7 including the authentication ID and the electronic certificate.

The electronic commerce site 1 transmits the authentication request message in response to the authentication ID response message M7 (at step S7). This is transmitted to the authentication device 2 in the form of an authentication request message M8 as shown in FIGS. 6 and 7. It is to be noted that since the authentication ID notified to the electronic commerce site 1 is encrypted as mentioned above, the authentication ID is useless for the electronic commerce site 1 and user individual information never leaks.

The authentication device 2 having received the authentication request message M8 executes an authentication ID decryption (at step S8) and an authentication determination (at step S9) to return the authentication response message M5 to the electronic commerce site 1.

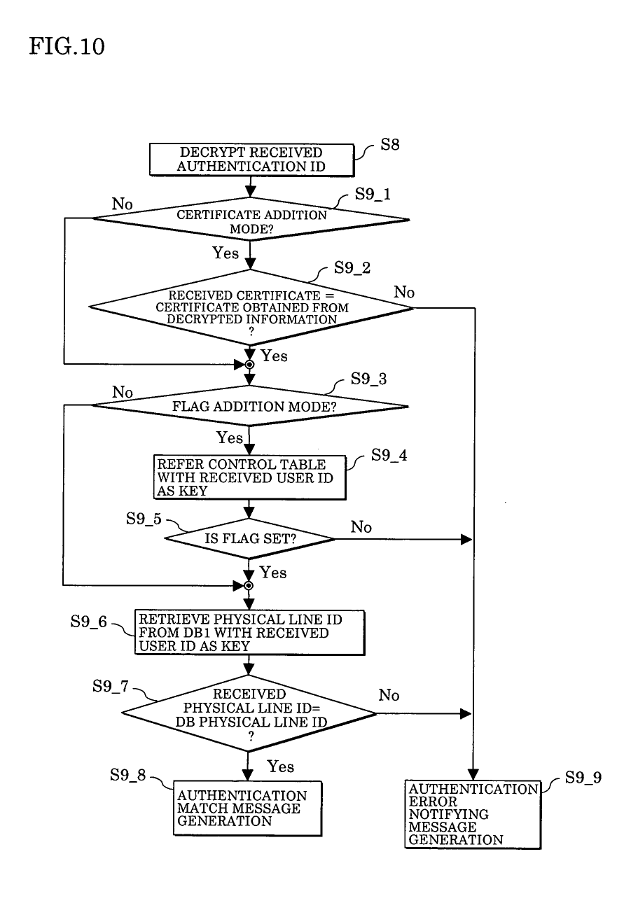

FIG. 10 shows a processing flow at steps S8 and S9 in the authentication device 2. Firstly, the authentication device 2 decrypts the encrypted authentication ID included in the message M8 (at step S8). Then, whether or not the authentication device 2 is set to the certificate addition mode is determined in the same way as step S5_4 of FIG. 8 (at step S9_1). Only when it is set to the certificate addition mode, it is determined whether or not the electronic certificate generated at step S5_5 of FIG. 8 and transmitted at step S5_6 is coincident with the electronic certificate obtained from the information after decrypting at step S8 (at step S9_2).

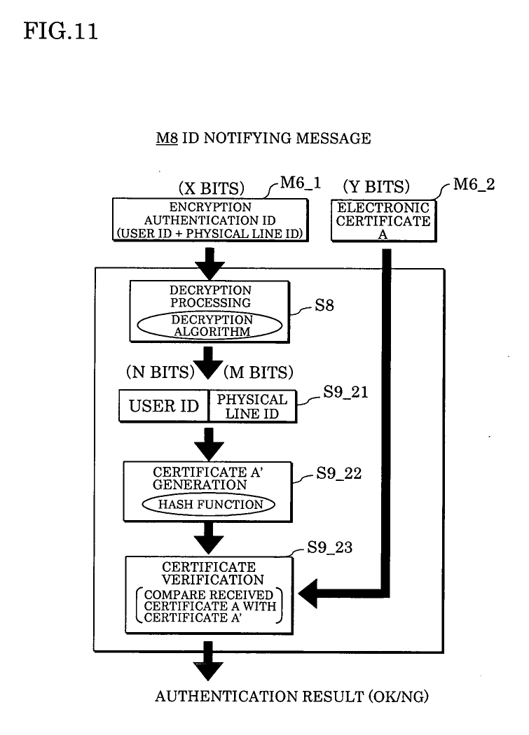

FIG. 11 more specifically shows a verification flow of the electronic certificate shown at steps S8 and S9_2 of FIG. 10. In this verification flow, decryption processing is performed to the message M6_1 (at step S8) within the message M6_1 of the encrypted authentication ID and the message M6_2 including the electronic certificate A generated in FIG. 9 and included in the authentication request message received from the electronic commerce site 1, so that the original user ID and physical line ID are decrypted (at step S9_21). By multiplying the user ID and the physical line ID thus obtained by the hash function in the same way as the above, the electronic certificate A′ is internally generated (at step S9_22) and the electronic certificate A′ is compared with the electronic certificate A included in the message M6_2 (at step S9_23), so that the authentication result (OK/NG) can be obtained.

When the authentication result indicates that both are not coincident with each other, the error message M5 is notified to the electronic commerce site 1 as a user authentication error (at step S9_9). When both are coincident with each other, whether or not the authentication device is set to the flag addition mode corresponding to step S5_1 of FIG. 8 is determined (at step S9_3). Only when being set to the flag addition mode, the authentication device refers the control table CT with the received user ID as a key (at step S9_4), and determines whether or not the flag is set (at step S9_5).

As a result, if the flag is not set, the access is regarded as an unauthorized access and the process proceeds to step S9_9 in the same way as the above. When the flag is set, the flag is reset, the physical line ID is retrieved from the database DB1 in the same way as step S4_3 of FIG. 8 with the received user ID as a key (at step S9_6), and whether or not this retrieved physical line ID is equal to the received physical circuit ID is determined (at step S9_7).

As a result, when both are not coincident with each other, the error message M5 is transmitted to the electronic commerce site 1 (at step S9_9). When both are coincident with each other, the message M5 indicating the authentication match is transmitted to the electronic commerce site 1 (at step S9_8).

Thus, in the embodiment (2), even if a malicious user uses a user ID improperly obtained, the ID is not coincident with the database information when the ID is notified to the authentication device since the physical line ID of the malicious user is assigned. Accordingly, the access can be determined to be an unauthorized access. Also, if the user ID and the physical line ID have been known, it can be determined to be unauthorized ID information by assigning the electronic certificate at the access node. Also, for the authentication request from the electronic commerce site, the IDs except authentication IDs properly issued are regarded as unauthorized by encrypting, a flag control, or the electronic certificate generated by the authentication device, thereby enabling an unauthorized access to be prevented.

### Embodiment 3

In the embodiments 1 and 2, an authentication of an access source of a user is aimed. However, it is also possible to authenticate other information concurrently with the access source authentication. Hereinafter, an example of authenticating an IP address of a fixed terminal of a user who uses the electronic commerce site will be described.

Firstly, a field (not shown) for storing an IP address is provided on the control table CT of the database portion 21 of the authentication device 2.

When receiving the ID notifying message M3 from the fixed terminal 4, the authentication device 2 extracts the IP address of the fixed terminal 4 included in the ID notifying message M3, and stores the concerned IP address in the field corresponding to the concerned user in the above-mentioned control table CT. When the electronic commerce site 1 transmits an authentication request to the authentication device 2, an IP address of a user who desires to authenticate is included in the authentication request message. The authentication device 2 performs the access source authentication as described in the embodiment 2, obtains IP address information from the control table CT with the user ID as a database key, and compares the IP address notified from the electronic commerce site 1 with the IP address obtained from the database, thereby enabling the validity of the IP address of the user to be verified.

1. An access source authentication method comprising:
a first step of adding an ID of a physical line, through which a message has passed, to the message including a user ID from a fixed terminal of a user to be transferred through the physical line; and
a second step of managing a relationship between a user ID and a physical line ID by a database, receiving the user ID and the physical line ID transferred by the first step and performing a user authentication by comparing the user ID and the physical line ID received with those in the database.

2. The access source authentication method as claimed in claim 1, wherein the second step generates an authentication ID in which the user ID and the physical line ID are encrypted, transmits the authentication ID to a request source of the authentication ID through a request destination of the authentication ID, and performs the user authentication by decrypting the authentication ID to obtain the user ID and the physical line ID when an authentication request including the authentication ID is received from the request source.

3. The access source authentication method as claimed in claim 1, wherein the first step further adds an electronic certificate to the message in addition to the physical line ID, and the second step verifies a validity of the user ID and the physical line ID in addition to the user authentication.

4. The access source authentication method as claimed in claim 2, wherein when transmitting the authentication ID, the second step sets a flag indicating a presence/absence of an issue of the authentication ID, and when receiving the authentication request for the authentication ID from the request source, the second step prevents an unauthorized access by a determination of the presence/absence of the flag.

5. The access source authentication method as claimed in claim 2, wherein the second step periodically changes an encryption key for generating the authentication ID.

6. The access source authentication method as claimed in claim 2, wherein the second step incorporates an electronic certificate in the authentication ID, and verifies a validity of the authentication ID when the authentication request is received from the request source.

7. The access source authentication method as claimed in claim 2, wherein when receiving the message from the fixed terminal the second step extracts an IP address of the fixed terminal to be stored in the database, and when receiving the authentication request including an IP address of the user from the request source the second step performs an authentication of the IP address of the fixed terminal by notifying the IP address of the fixed terminal from the request source.

8. An access source authentication system comprising:
a node which is connected to a fixed terminal of a user by a physical line and which adds an ID of a physical line, through which a message has passed, to the message including a user ID from the fixed terminal to be transferred; and
an authentication device which has a database for managing a relationship between a user ID and a physical line ID, and which performs a user authentication by comparing the user ID and the physical line ID from the node with those in the database.

9. The access source authentication system as claimed in claim 8, wherein the authentication device generates an authentication ID in which the user ID and the physical line ID are encrypted, transmits the authentication ID to a request source of the authentication ID through a request destination of the authentication ID, and performs the user authentication by decrypting the authentication ID to obtain the user ID and the physical line ID when an authentication request including the authentication ID is received from the request source.

10. The access source authentication system as claimed in claim 8, wherein the node further adds an electronic certificate to the message in addition to the physical line ID, and the authentication device verifies a validity of the user ID and the physical line ID in addition to the user authentication.

11. The access source authentication system as claimed in claim 9, wherein when transmitting the authentication ID, the authentication device sets a flag indicating a presence/absence of an issue of the authentication ID, and when receiving the authentication request for the authentication ID, the authentication device prevents an unauthorized access by a determination of the presence/absence of the flag.

12. The access source authentication system as claimed in claim 9, wherein the authentication device periodically changes an encryption key for generating the authentication ID.

13. The access source authentication system as claimed in claim 9, wherein the authentication device incorporates an electronic certificate in the authentication ID, and verifies a validity of the authentication ID when the authentication request is received from the request source.

14. The access source authentication system as claimed in claim 9, wherein when receiving the message from the fixed terminal the authentication device extracts an IP address of the fixed terminal to be stored in the database, and when receiving the authentication request including an IP address of the user from the request source the authentication device performs an authentication of the IP address of the fixed terminal by an IP address from the request source.
